(19) United States
(12) Patent Application Publication
(10) Pub. No.: US 2026/0063518 A1
(43) Pub. Date: Mar. 5, 2026

(54) DEVICE FOR TRAPPING RARE CELLS FROM FLUID SAMPLES

(71) Applicants: Pradyumna Kedarisetti, Edmonton (CA); Samantha Leier, Edmonton (CA); Frank R. Wuest, Edmonton (CA); Roger J. Zemp, Edmonton (CA)

(72) Inventors: Pradyumna Kedarisetti, Edmonton (CA); Samantha Leier, Edmonton (CA); Frank R. Wuest, Edmonton (CA); Roger J. Zemp, Edmonton (CA)

(21) Appl. No.: 18/824,882

(22) Filed: Sep. 4, 2024

(51) Int. Cl. G01N 1/40

(52) U.S. Cl. CPC G01N 1/405

(57) ABSTRACT

A system for collecting biomarkers from a fluid stream includes a collection vessel having at least one fluid port that is adapted to be in fluid communication with the fluid stream. The collection vessel defines an inner volume. A 3D scaffold is disposed within the inner volume of the collection vessel. The 3D scaffold is chemically functionalized to bind the biomarkers in the fluid stream, wherein the biomarkers are eukaryotic cells of interest, extracellular vesicles associated with the eukaryotic cells of interest, or combinations thereof. A fluid driver circulates the fluid stream through the collection vessel via the at least one fluid port such that the fluid stream interacts with the 3D scaffold.

### TECHNICAL FIELD

This relates to a device for trapping rare cells from fluid samples, in particular a device that use a three-dimensional scaffold.

### BACKGROUND

Metastatic disease accounts for more than 90% of cancer deaths. Detection of circulating tumor cells (CTCs) is an important prognostic step in the prevention of metastatic disease. However, their low abundance provides a significant challenge in their quantification for prognostication. Current CTC trapping technologies include isolation by physical or morphological properties, such as size, density or epithelial cell adhesion molecule (EpCAM)-overexpression. However, some CTCs may not be successfully trapped by these technologies, especially small CTCs or EpCAM-negative CTCs undergoing epithelial-mesenchymal transition (EMT). Due to significant variations among different tumor types, there has not been a universal tumor liquid biopsy technique that is valid for all cancer diagnosis and prognosis. Compared to circulating tumor DNA (ctDNA) and exosomes, CTCs are a more complete biological entity that can provide dynamic information of proteins, DNA, RNA, etc. They can also be cultured in vitro to build CTC lines for further studies on metastatic mechanisms, prevention, and intervention. To this end, an ideal technology must be sufficiently versatile to target a heterogeneous subpopulation of CTCs and enable viability preserving release for further in-vitro culture and analysis. More importantly, targeting CTCs via different interactions between nanoprobes and tumor cells must curb the influence of serum protein in the physiological environment. CTC detection and identification are also complicated by its rarity (one CTC out of a billion cells), cancer heterogeneity, and dynamic changes in cell biological properties during the metastasis process. Clinically, molecular profiling based on CTC studies provides critical information for developing treatment strategies and monitoring metastasis and recurrence.

Examples of commercial technologies for CTC enrichment include magnetic nanoparticles, in vivo technologies, microfluidics and dual modality products. Though several microfluidic separation technologies have shown some success in separating CTCs from whole blood, the issue of low abundance of CTCs in a typical blood sample as well as long processing times remains a challenge. For example, commercially available HB Chip can process blood samples at a rate of 4.8 mL per hour, which poses a challenge for processing of large volumes of blood. Targeted magnetic nanoparticles have also shown some success in CTC trapping in vivo, with a major drawback being the need for injection of nanoparticles.

Previous CTC enrichment technologies can be categorized as: magnetic nanoparticle-based, in vivo-based, microfluidic-based and dual modality-based technologies.

Magnetic nanoparticle-based technologies include CELLSEARCH®, in which an EpCAM targeted magnetic nanoparticles for CTC trapping is disclosed, for example, by U.S. Pat. No. 6,623,982 (Liberti et al.), entitled “Increased separation efficiency via controlled aggregation of magnetic nanoparticles”. Another magnetic nanoparticle-based technology includes AdnaTest®, an antibody functionalized EpCAM or MUC-1 targeted magnetic nanoparticles for CTC trapping disclosed by U.S. Pat. No. 8,557,577 (Hauch et al.), entitled “Solid phase cell isolation and/or enrichment method.” Similarly, MACS® system uses antibody functionalized, CTC targeted magnetic nanoparticles for CTC trapping in blood samples after centrifugation and application of a magnetic field disclosed by European patent no. EP2597153 (Kauling et al.), entitled “Cell separation method.” An automated system, MagSweeper™, includes EpCAM targeted magnetic beads which bind CTCs and are collected from blood samples with a magnetic rod, disclosed by U.S. Pat. No. 8,071,395, (Davis et al.), entitled “Methods and apparatus for magnetic separation of cells,” and U.S. Pat. No. 9,267,943, (Davis et al.), entitled “Apparatus for magnetic separation of cells.”

In vivo-based technologies include GILUPI CellCollector®, an EpCAM targeted gold coated stainless steel wire for in vivo isolation of CTCs disclosed by US Patent application publication no. 2015/0323533, (Sass et al.), entitled “Detection device for the in vivo and/or in vitro enrichment of sample material.”

Microfluidic-based technologies include various CTC targeted microfluidic chips, such as Modular Sinusoidal Microsystems, an antibody functionalized chip for CTC trapping and enumeration. Geometrically enhanced differential immunocapture (GEDI), an antibody functionalized HER2 and prostate-specific membrane antigen (PSMA) targeted chip for CTC trapping (up to 27 CTCs per mL) was disclosed by PCT publication no. WO2013109944A1 (Rhim et al.) entitled “Methods for assessing risk for cancer using biomarkers.” HB (or herringbone) Chip, an antibody functionalized chip for CTC trapping (up to 12 CTCs per mL, at a rate of 4.8 mL per hour) was disclosed by Australian patent no. AU2015300776B2 (Jiang et al.) entitled “Platelet-targeted microfluidic isolation of cells,” and United States patent application publication no. 2019/0072465 (Toner et al.) entitled “Capturing particles.” GEM chip, an antibody functionalized EpCAM targeted geometrically enhanced mixing (GEM) chip for CTC trapping (at a rate of 3.6 mL per hour) was disclosed by US patent application publication no. 2016/0091489 A1 (Fan et al.) entitled “Devices and methods for isolating cells.” OncoCEE®, an antibody functionalized EpCAM targeted chip for CTC trapping and subsequent cytogenetic characterization was disclosed by U.S. Pat. No. 9,671,407 (Mikolajczyk et al.) entitled “Devices and methods of cell capture and analysis.” LiquidBiopsy™, an antibody functionalized chip for CTC trapping and subsequent automated DNA analysis was disclosed by U.S. Pat. No. 8,263,387 (Pagano et al.) entitled “Sheath flow devices and methods.” Finally, GO Chip™, an EpCAM targeted graphene oxide (GO) nanosheets on a gold chip for CTC trapping was disclosed by US patent application publication no. 2021/0060229 (Nagrath et al.) entitled “Indwelling intravascular aphaeretic system for in vivo enrichment of circulating tumor cells.”

Dual modality-based technologies include Ephesia, an antibody functionalized EpCAM targeted magnetic particles assembled in microfluidic columns for CTC trapping, while cell viability is preserved. IsoFlux®, a targeted magnetic particles for CTC trapping also includes subsequent genetic analysis, assembled in a microfluidic system. Quadrupole magnetic separator, a negative enrichment technology, has been designed based on antibody-mediated and magnetic-mediated removal of non-CTCs in blood samples. Finally, CTC-iChip, a CTC enrichment chip technology using either EpCAM targeted positive enrichment strategies or antibody-mediated negative enrichment strategies has been disclosed by PCT publication no. WO2009051734 (Nagrath et al.) entitled “Microchip-based devices for capturing circulating tumor cells and methods of their use.”

### SUMMARY

According to an aspect, there is provided a system for collecting biomarkers from a fluid stream, the system comprising a collection vessel having at least one fluid port that is adapted to be in fluid communication with the fluid stream, the collection vessel defining an inner volume, a 3D scaffold disposed within the inner volume of the collection vessel, the 3D scaffold being chemically functionalized to bind the biomarkers in the fluid stream, wherein the biomarkers are eukaryotic cells of interest, extracellular vesicles associated with the eukaryotic cells of interest, or combinations thereof, and a fluid driver that is adapted to circulate the fluid stream through the collection vessel via the at least one fluid port such that the fluid stream interacts with the 3D scaffold.

According to other aspects, the system may comprise one or more of the following features, alone or in combination: the 3D scaffold may be chemically functionalized to bind uniquely to the biomarkers; each of the at least one fluid port may be in fluid communication with a bore of a cannula or a lumen of a needle; the 3D scaffold may comprise beads, fibers, mesoporous structures, or combinations thereof; a smallest dimension of the 3D scaffold may be larger in size than biological cells in the fluid stream; a material of the 3D scaffold may comprise silica, glass, quartz, polymer plastics, dielectrics, silicon nitride, gallium nitride, polyethylene glycol, ceramics, or combinations thereof; the 3D scaffold may have a volume of at least 1 mL; the 3D scaffold may be functionalized by one or more linker chemistries comprising amine-functionalization (such as via COOH, NCS or NHS chemistries), thiol-maleimide, and/or biotin-streptavidin; the 3D scaffold may carry targeting compounds that comprise folic acid, RGD peptide, antibodies, peptidomimetics, small molecules, or combinations thereof; the 3D scaffold may carry targeting compounds that are adapted to bind to EpCAM, EGFR, folate receptors, PSMA, or combinations thereof; the fluid driver may have a flow rate of at least 1 mL/minute; the biomarkers may be released from the 3D scaffold using an elution buffer; the collection vessel may comprise an inlet and an outlet, and wherein the fluid driver draws fluid in via the inlet and exhausts the fluid via the outlet; the fluid driver may draw fluid in and exhausts fluid via a common fluid port; and the fluid driver may comprise a fluid pump, a reciprocating plunger, or a variable pressure chamber.

According to an aspect, there is provided a method of collecting biomarkers, the method comprising connecting at least one fluid port of a collection vessel to a source of fluid, the collection vessel carrying a 3D scaffold within an inner volume defined by the collection vessel, the 3D scaffold being chemically functionalized to bind the biomarkers in a fluid stream, wherein the biomarkers are eukaryotic cells of interest, extracellular vesicles associated with the eukaryotic cells of interest, or combinations thereof, circulating a fluid stream from the source of fluid through the collection vessel such that the fluid stream interacts with the 3D scaffold and such that the 3D scaffold binds to the biomarkers carried in the fluid stream, wherein at least 10 mL of fluid circulates through the collection vessel, returning the fluid stream to the source of the fluid, and releasing the biomarkers from the 3D scaffold into a sample vial.

According to other aspects, the method may comprise one or more of the following features, alone or in combination: connecting the at least one fluid port to a source of fluid may comprise using a cannula or a needle; at least 100 mL may be circulated through the collection vessel; the 3D scaffold may be functionalized by one or more linker chemistries comprising amine-functionalization (such as via COOH, NCS or NHS chemistries), thiol-maleimide, or biotin-streptavidin; the 3D scaffold may carry targeting compounds that comprise folic acid, RGD peptide, antibodies, peptidomimetics, small molecules, or combinations thereof; the 3D scaffold may carry targeting compounds that are adapted to bind to EpCAM, EGFR, folate receptors, PSMA, or combinations thereof; fluid may be circulated through the collection vessel at a rate of at least 1 mL/minute; the method may further comprise the step of releasing the cells of interest using an elution buffer; the 3D scaffold may be chemically functionalized to bind uniquely to the biomarkers such that the sample collected comprises a higher concentration of the biomarkers without substantial changes to relative concentrations of background components in the fluid stream.

According to an aspect, there is provided a 3D CTC-trapping scaffold designed to selectively trap CTCs in whole blood through an IV system, which allows for multiple passes of blood through the scaffold. This strategy allows for amplification of CTCs in whole blood volume with high throughput, while circumventing drawbacks of prior technologies such as invasiveness, injection of nanoparticles, use of costly antibodies and long processing times.

According to another aspect, there is provided a trapping device for sampling rare cells from total systemic volumes of patient fluids comprising collection vial(s), a fluid collection system, a fluid return system, a trapping system comprising an in-line functionalized 3D scaffold for cell trapping such that fluid flows through the scaffold and selectively traps rare cells of interest with minimal binding of other cells, the 3D scaffold comprising a structural material functionalized on one or more surfaces with targeting compounds targeted to surface receptors present on the rare cells of interest, the fluid collection and return system is configured to enable trapping of cells from a greater volume of fluid than the sample vial alone, fluid volumes samples which are in excess of the collection vial volume are returned to the subject, and fluids volumes drawn from the patient are transferred to the collection vial and the total volume of the collection vial is again returned to the patient less the cells trapped in the scaffold.

According to an aspect, there is provided a method of trapping rare cells from large blood volumes without collecting blood volumes exceeding maximum allowable blood loss volumes, the method comprising drawing blood from a subject using a transcutaneous fluid guide, contacting the trapping scaffold material, and returning the blood to the subject using a transcutaneous fluid guide, and after conclusion of fluid sampling procedure, the trapped cells of interest are released from the trapping scaffold into a collection vial.

According to an aspect, there is provided a method for creating a rare cell sampling system the method comprising production of a 3D trapping scaffold composed of subunits with the smallest dimension larger in size than biological cells in a sampled body fluid, trapping scaffold consists of material suitable to withstand physical forces present in the fluid system without fragmentation, modification of the scaffold material to introduce chemically reactive groups, addition of targeting molecules to the chemically reactive groups on the scaffolds which will target rare cells and is stable in bodily fluids and non-toxic to humans, packing functionalized scaffold material into an intermediary flow through container attached to a draw and/or return system, and incorporation of a filter to reject passage of scaffold materials, the filter comprising porous material with pore size which allow of passage of biological cells but not scaffold materials.

According to other aspects, the fluid collection and/or return system may comprise a syringe, fluid container, vial needle/catheter, pump vacutainer, or low pressure device, the targeting compounds on the scaffolds may comprise folate or folic acid, arginylglycylaspartic acid (RGD) peptide, antibodies, peptidomimetics, or small molecules, the targeting compounds may bind to EpCAM, epidermal growth factor receptor (EGFR), folate receptors, or prostate-specific membrane antigen (PSMA), linker chemistries may comprise amine-functionalization (such as via COOH, NCS or NHS chemistries), thiol-maleimide, or biotin-streptavidin; the total volume of the sample for trapping may be equal to or greater than 10 mL, or 100 mL, or 1 L, the entire patient blood volume, or the maximal allowable blood loss limit in a human subject of 450 mL blood loss per 56 days as per Canadian Blood Services, debris introduced during return of the fluids to the patient are below microdosing guidelines, fluid flow rates may be greater than 1 mL/min, or 5 mL/min, or 10 mL/min, trapping material amounts may be greater than 100 mg, or 200 mg, or 1 g, or 10 g, scaffold material may comprise silica, glass, quartz, polymer plastics, dielectrics, silicon nitride, gallium nitride, polyethylene glycol, or ceramics, form factors of scaffold material may comprise smaller functional units comprising fibres, beads, or mesoporous structures, sampling and return fluid guides may be the same, addition of targeting compounds may be via either a linker compound or direct functionalization to the scaffold material, and release of trapped cells may be accomplished via an elution buffer or other solution comprising trypsin, phospholipase, or amylase.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purposes of illustration only and are not intended to be in any way limiting, wherein:

FIG. 1 is a schematic diagram of a system for sampling biomarkers from a fluid stream.

FIG. 2 is a schematic diagram of a system for sampling biomarkers from a fluid stream that uses a syringe to drive the fluid stream.

FIG. 3 is a schematic diagram of a system for sampling biomarkers from a fluid stream that uses a cannula and syringe pump to automate collection and return of fluid.

FIG. 4 is a schematic diagram of a system for sampling biomarkers from a fluid stream that uses a peristaltic pump to pump fluid between a first cannula and a second cannula.

FIG. 5 is a schematic diagram of the system of FIG. 4 with pressure monitors.

FIG. 6 is a schematic diagram of a system for sampling biomarkers from a fluid stream that uses a peristaltic pump to pump fluid to and from a dual-shafted cannula.

FIG. 7 is a schematic diagram of a system for sampling biomarkers from a fluid stream where vacuum or pressure is used to draw or return fluid.

FIG. 8 is a schematic diagram of a method for releasing biomarkers from the system for sampling biomarkers.

FIG. 9 is a schematic diagram of a scaffold for a system for sampling biomarkers with folate functionalized glass spheres.

FIG. 10 is a schematic diagram of a scaffold for a system for sampling biomarkers with PSMA-functionalized glass spheres.

FIG. 11 is a schematic diagram of a scaffold for a system for sampling biomarkers with folate functionalized fiberglass.

### DETAILED DESCRIPTION OF PREFERRED EMBODIMENTS

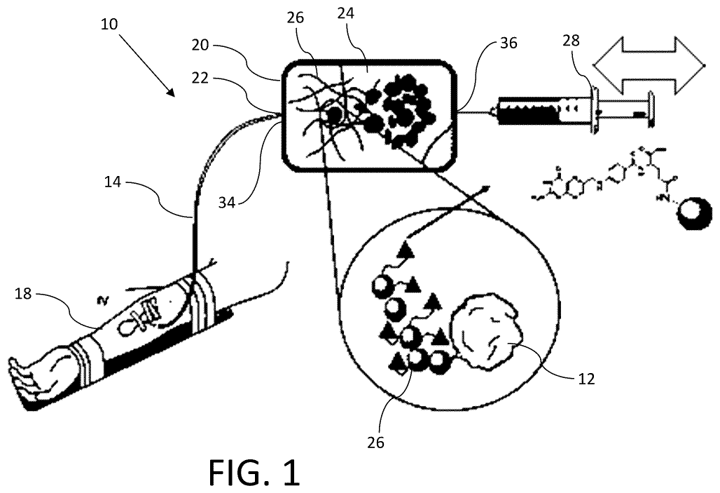

A system, generally identified by reference number 10, will now be described with reference to FIG. 1 through 11. System 10 is used for sampling biomarkers 12 from a fluid stream 14. In one example, system 10 may be used to sample cancer cells from a blood stream. In other examples, system 10 may be used to sample other types of biomarkers 12 from other fluid streams 14. Unless it is clear from the context, it will be understood that a discussion of specific aspects of a given application may apply more generally to other applications, or in other words, other biomarkers and fluid streams, with appropriate modifications. In the discussion below, the biomarkers may include cells or vesicles of interest indicative of a particular condition, such as certain types of cancer.

System 10 may be used to selectively isolates circulating tumor cells or other bloodborne biological entities (e.g. extracellular vesicles, stem cells, immune cells of interest such as chimeric antigen receptor (CAR)-T cells, T lymphocytes) with high purity from biological fluid samples such as blood, urine and semen. A high purity enriched sample includes eukaryotic cells of interest or associated extracellular vesicles drawn from the fluid stream, while excluding or minimizing bacterial and viral pathogens, and background blood (or other) cells from the enriched cell fraction. It will be understood that in any sample that includes the fluid sample will also inherently include background components already present in the fluid sample as the scaffold is designed to bind certain components but does not exclude others. In particular the scaffold may be designed to trap or capture specific cells without trapping or capturing undesired biological components. However, there may be some fluid that accompanies the scaffold, or that may remain within the collection vessel, and therefore may be present in the collected sample. As such, a fluid sample extracted from the container will preferably have a greater concentration of the targeted biomarkers as well as other background components that already present in the fluid stream, which may be present at the same relative concentration, or at a reduced concentration. In some examples, the relative concentration of these background components may remain relatively constant. By way of example, background components in a blood sample may include blood cells, bacteria, protein, viruses, etc. The concentration of these components may remain substantially the same, while the targeted biomarkers that bind to the scaffold, when present in the fluid stream being tested, would be expected to have a higher concentration in the collected sample once released from the scaffold.

The device described here utilizes a 3D scaffold that is chemically altered to outwardly present moieties which bind to epitopes typically overexpressed in cancerous cells or other rare cells or biological components of interest. Blood flows through the scaffold and rare cells present in the blood expressing complementary epitopes to the targeting moieties attach themselves to the scaffold. System 10 may be used to sample a substantial portion of a fluid stream, such as up to the whole blood volume of a patient, while only withdrawing small amounts of blood at any given time. System 10 may be implemented without any exogenous agents to be injected into a living subject.

In one example, after the sampling procedure, the scaffold may be subsequently washed several times to remove weakly bound and non-specifically bound cells. Circulating tumor cells captured in this manner are detached and eluted from the scaffolding material by incubation in an elution buffer (e.g. trypsin, phospholipase, amylase) capable of cleaving either the moiety from the scaffold or the epitope from the cell. After incubation, the cells are no longer attached to the scaffold and are eluted into a buffer solution. Cells captured via this methodology are not stained with or bound to exogenous agents post-elution and typically do not suffer a reduction in viability. Cells may be used for downstream analysis including but not limited to microscopy, flow cytometry, sub-culturing and genetic sequencing and analysis.

Referring to FIG. 1, system 10 has a collection vessel 20 that has at least one fluid port 22 and defines an inner volume 24. The at least one fluid port 22 is adapted to be in fluid communication with fluid stream 14. A 3D scaffold 26 is disposed within inner volume 24 and is chemically functionalized to bind biomarkers 12 that are carried by fluid stream 14. System 10 has a fluid driver 28 that is adapted to circulate fluid stream 14 through collection vessel 20 via the at least one fluid port 22 such that fluid stream 14 interacts with 3D scaffold 26. Fluid driver 28 may draw fluid stream 14 in and exhaust fluid stream out of a common port, such as the at least one fluid port 22, or one of the one or more fluid ports 22 may be an inlet 34, and collection vessel 20 may have an outlet 36, where fluid driver 28 draws fluid stream 14 into collection vessel 20 through inlet 34, and exhausts fluid stream 14 via outlet 36. As described below, fluid driver 28 may be a fluid pump, a reciprocating plunger, or a variable pressure chamber. Fluid driver 28 may pump fluid at a rate of at least 1 mL/min. Where the system is a closed loop, this rate will define the flow rate through collection vessel 20 as well. In other embodiments, a flow rate greater than 5 mL/min, or greater than 10 mL/min may be used. Collection vessel 20 may have a volume of 10 mL or more.

System 10 may have a filter 40 that is sized to allow the passage of fluid stream 14 into and out of collection vessel 20 and prevent the passage of 3D scaffold out of collection vessel 20. There may be a filter 40 positioned at each of the at least one fluid port 22. Each of the at least one fluid port 22 may be in fluid communication with a more of a bore of a cannula or a lumen of a needle. System 10 may have a sample container 30 in fluid communication with collection vessel 20, where sample container 30 receives a fluid sample 32 from collection vessel 20. Sample container 30 may receive fluid stream 14 from collection vessel 20 through outlet 36.

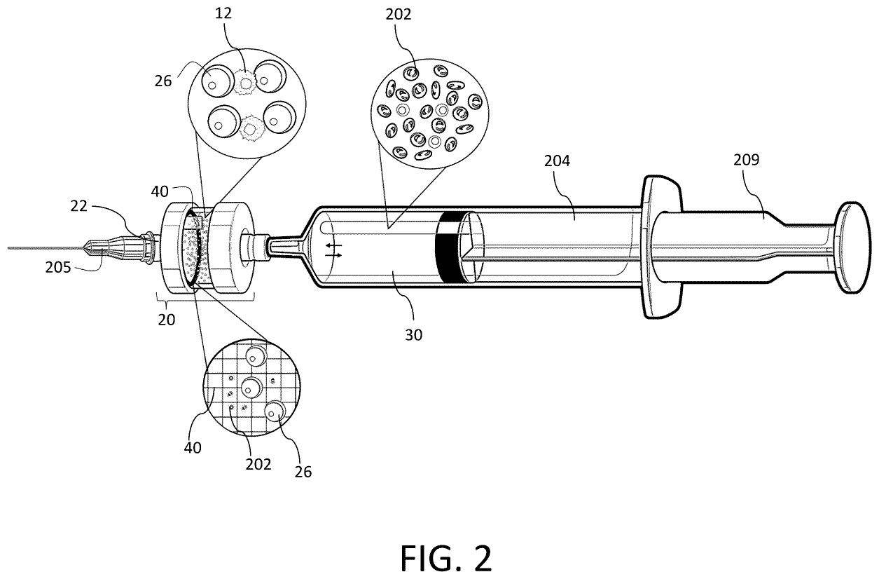

Referring to FIG. 2, where 3D scaffold 26 may be encapsulated into inner volume 24 of a collection vessel 20 which attaches between a needle 205 and sample container 30 which is a syringe 204. Syringe 204 may be used to draw and return blood multiple times, each cycle potentially trapping successively more circulating biomarkers 12. Syringe 204 may include a plunger 209 to be fluid driver 28.

3D scaffold 26 may be non-planar and may be movable with collection vessel 20. In other examples, 3D scaffold 26 may be integrated with and/or fixed relative to collection vessel 20. 3D scaffold 26 may be designed to provide a larger surface area relative to a two-dimensional surface, and may permit fluid to flow through 3D scaffold 26, or where 3D scaffold is made of discrete components, between the discrete components. Where 3D scaffold is moveable within collection vessel 20, the at least one fluid port 22 may be configured to allow passage of fluid stream 14 an restrict the passage of 3D scaffold 26. 3D scaffold may be formed from beads, fibers, mesoporous structures, or combinations thereof and may be made from materials such as silica, glass, quartz, polymer plastics, dielectrics, silicon nitride, gallium nitride, polyethylene glycol, ceramics, or combinations thereof. The material of 3D scaffold 26 may be chosen such that it is sufficient to withstand forces applied by circulating fluid stream 14. The smallest dimension of the 3D scaffold is preferably larger in size than biological cells 202 in fluid stream 14. 3D scaffold 26 may have a volume of at least 1 mL, and may have a mass of more than 100 mg, or 200 mg, or 1 g, or 10 g.

3D scaffold 26 may be functionalized by linker compounds, functionalization of a surface of the 3D scaffold 26, of combinations thereof. Where 3D scaffold 26 is functionalized by linker compounds, the linker chemistries may be one or more of: amine-functionalization, thiol-maleimide, or biotin-streptavidin. 3D scaffold may carry targeting compounds that are adapted to bind to EpCAM, EGFR, folate receptors, PSMA, or combinations thereof.

3D scaffold 26 may have a structural material functionalized on one or more surfaces with targeting compounds adapted to bind surface receptors present on biomarkers 12. Biomarkers 12 that have been bound by 3D scaffold 26 may be released using an elution buffer, trypsin, phospholipase of amylase.

In one example, 3D scaffold 26 may be composed of 70 μm amine-functionalized silica beads covalently linked to the targeting agent folate and contained between two tightly secured <70 μm nylon filters, thereby allowing cells to pass through while keeping 3D scaffold 26 in place. In this example, biological cells 202 may be blood cells, which are able to pass through 3D scaffold 26. Following multiple draws and returns of fluid stream 14, biomarkers 12 are liberated from the scaffold, such as via trypsin-mediated cleavage, and are collected in a collection vial, which can then be analyzed.

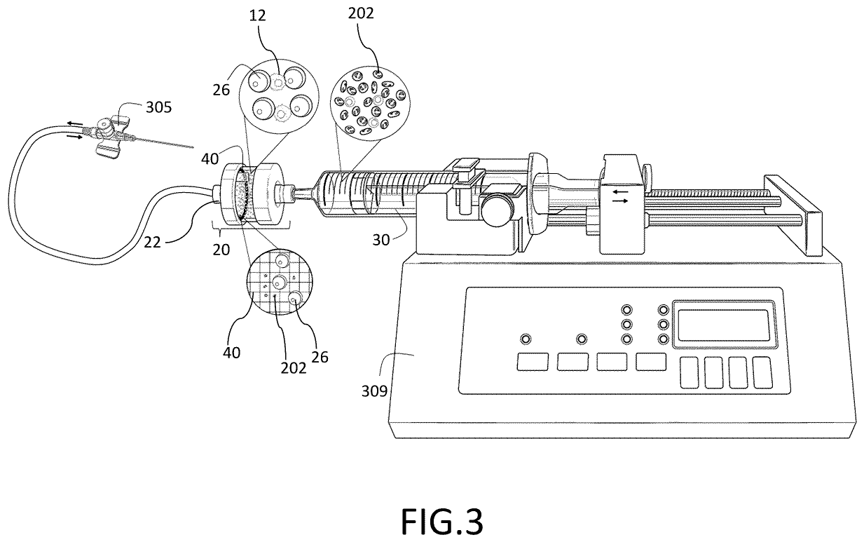

Referring to FIG. 3, a cannula 305 is used instead of syringe 204, and a syringe pump 309 that operates a reciprocating plunger may be used for as fluid driver 28 for fluid stream 14 from the subject.

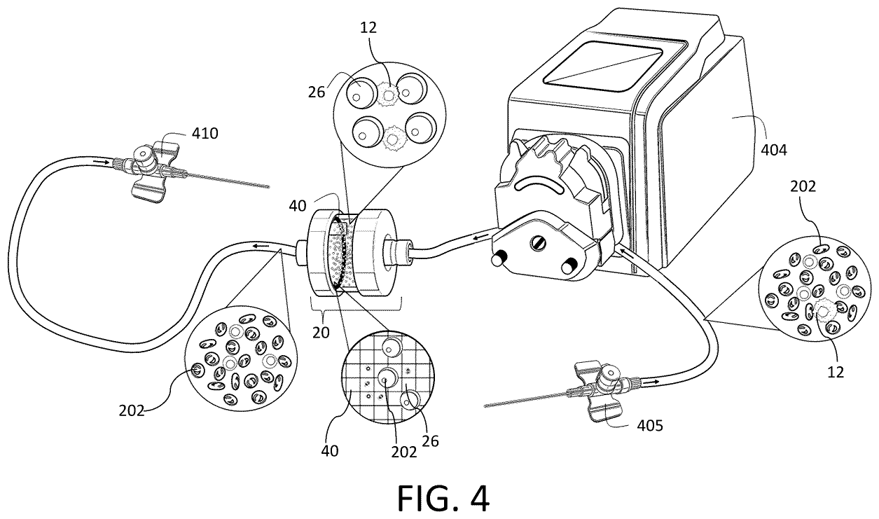

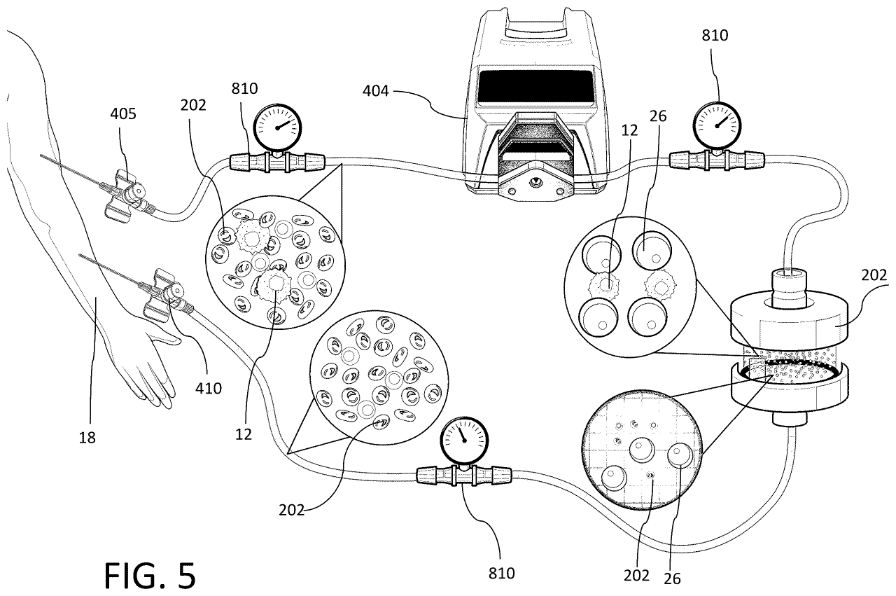

Referring to FIG. 4, a peristaltic pump 404 may be used in conjunction with a first cannula 405 (or needle) for withdrawing blood and a second cannula 410 for returning fluid stream 14 to a subject. Collection vessel 20 is connected in line between the first and second cannulas 405 and 410. System 10 may also include one or more pressure monitors 810, as shown in FIG. 5. Where source of fluid 18 is a patient's bloodstream, pressure monitors 810 may be used to monitor, for example, the arterial pressure adjacent to first cannula 405, the venous return pressure adjacent to second cannula 410, or an inflow pressure at an intermediate location in system 10. As depicted, the inflow pressure monitor 810 may be located between peristaltic pump 404 and collection vessel 20.

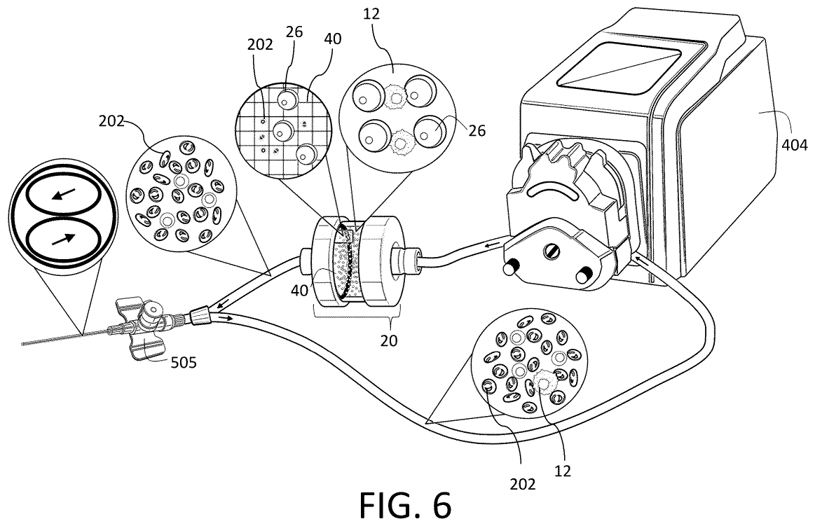

Referring to FIG. 6, system 10 may have a single dual-shafted cannula 505 where one shaft is for withdrawing fluid stream 14, and another for returning fluid stream 14.

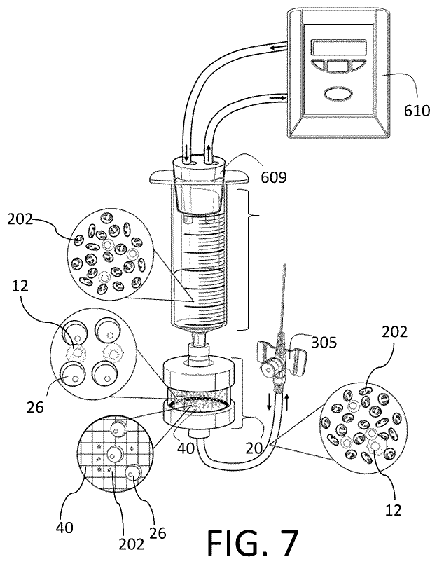

Referring to FIG. 7, vacuum or pressure may be used to draw or return fluid stream 14 in place of a plunger. A pneumatic regulator 610 may be used to maintain positive or negative pressure within sample container 30 to draw or return fluid stream 14. A stopper 609 may be used to seal sample container 30 to pneumatic regulator 610.

The 3D scaffold 26 may be composed of subunits with the smallest dimension larger in size than the target biomarkers, such as blood cells. The 3D scaffold 26 may be made from material suitable to withstand physical forces present in the system 10 without fragmentation. The targeting moieties on the surface of 3D scaffold 26 may comprise antibodies, RGD-peptides, other small molecules such as folic acid or peptidomimetics such as PSMA inhibitors.

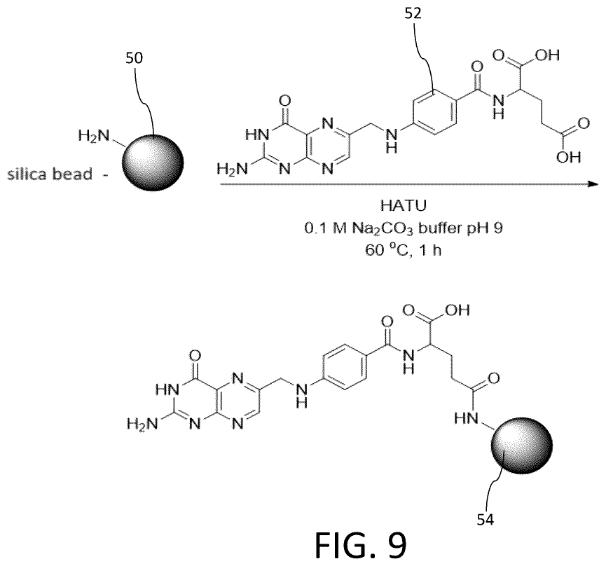

In one example, 3D scaffold 26 is designed based on a silica-bead or silica-fiber scaffold, the surface chemistry of the silica beads or fibers being modified to attach a targeting moiety. FIG. 9 shows a silica bead 50, a folate-targeting chemistry 52, and the resulting scaffold unit 54 of 3D scaffold 26 after functionalization. Other targeting moieties are also possible, for example EGFR, PSMA, EpCAM, EGFR, HER2, MUC-1, programmed death-ligand 1 (PD-L1), progesterone receptor gene (PGR), αVβ3, forkhead box protein A1 (FOXA1), forkhead box protein C1 (FOXC1), alpha-crystallin B chain (CRYAB), cytokeratin-19 (CK19), etc.

These targeting moieties may be attached to the 3D scaffold 26 material via one of several linker chemistries which includes the production of reactive groups on surface of 3D scaffold 26 such as amines, hydroxyl or carboxyl groups via either surface hydrations via the use of strong acids or bases, which may be followed by silanization with orthosilicates. The reactive groups may be conjugated to the functional targeting moieties via reactions such as amide bond formation, thiourea bond formation or condensation reactions.

An example of the manner in which system 10 may be used to collected biomarkers 12 from fluid stream 14 will now be described. In this example, the at least one fluid port 22 is connected to a source of fluid 18, and fluid stream 14 is circulated from the source of fluid 18 through collection vessel 20 such that fluid stream 14 interacts with 3D scaffold 26 and at least 10 mL of fluid circulates through collection vessel 20. Biomarkers 12 are bound to 3D scaffold. Fluid stream 14 is returned to source of fluid 18 and biomarkers 12 are released into a sample vial 708. The method may result in an amount of debris being introduced into source of fluid 18 that is less than microdosing guidelines. The amount of debris introduced, and therefore the design of the system and/or 3D scaffold, will depend on various factors, such as the material from which the 3D scaffold is made, and the expected amount of fluid circulation. The guidelines may have a different threshold of what is considered safe for different materials that may produce debris. Also, the amount of debris introduced into the fluid stream may be constant, or may increase over time due to wear on the 3D scaffold. As such, the design of the system and the threshold that is established may take into account a particular fluid flow rating, either by speed or by volume. While at least 10 mL of fluid is circulated, the amount of fluid may be at least 100 mL, 1 L, or, in the case that source of fluid 18 is a patient, the entire blood volume of a patient, that is circulated through collection vessel 20.

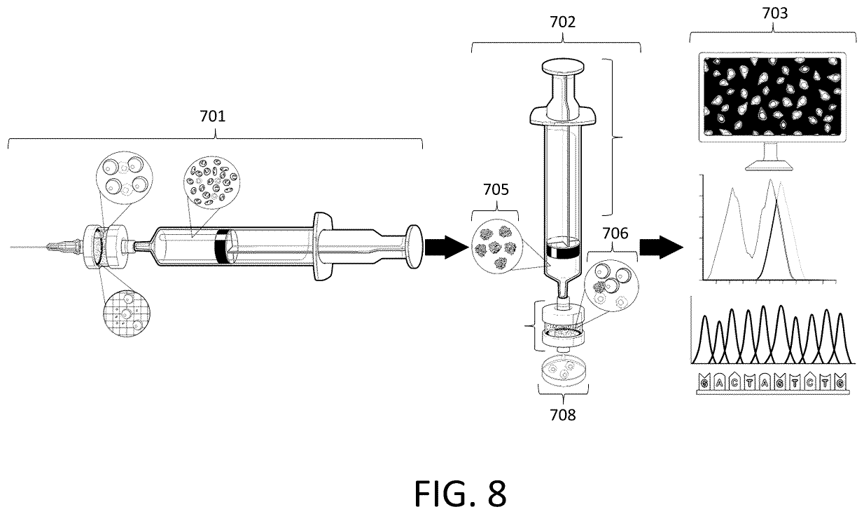

Referring to FIG. 8, an example of a method for releasing biomarkers 12 in sample vial 708 is shown. Biomarkers 12 are collected by system 10 in step 701. In step 702, trypsin or similar elution buffer 705 may be used in a syringe to flow through the cartridge containing 3D scaffold 26 and trapped biomarkers 12. The buffer may be used to release the trapped target cell from the targeting moiety or may be used to release the targeting molecule from the scaffolding material in step 706. Biomarkers 12 may be eluted into a blocking buffer which neutralizes the effect of the elution buffer to limit surface protein degradation.

The cells may be eluted to be largely viable, and available in step 703 for downstream procedures such as culturing, staining, microscopy, flow cytometry, sequencing, or other biomarker analysis.

Examples of methods for synthesizing the 3D scaffold 26 are discussed below as are example methods for performing the trapping experiments and handling specimens.

In one example, the folate receptor expressing human cancer cell line, KB (CRL-3596, ATCC) was used as model CTCs in spike-in experiments. KB cells were cultured in Dulbecco's Modified Eagle Medium (DMEM) High Glucose media supplemented with 10% fetal bovine serum (FBS) and 1% penicillin-streptomycin. All cells were utilized prior to 15 passages.

All blood samples were acquired via venipuncture into ethylenediaminetetraacetic acid dipotassium salt dihydrate (K₂EDTA) coated vacutainers. Feasibility and optimization experiments were performed using samples of up to 30 mL of bovine blood which was acquired in accordance with animal research ethics approval received from The University of Alberta Animal Care and Use Committee Livestock (AUP00003061).

The proposed approach may use silica scaffolds to enable continuous filtering of bodily fluids for CTC enrichment. In this approach, 70 μm silica beads may be decorated with a targeting agent, such as folate. As the folate receptor is overexpressed in several cancers, the expectation is that this would allow for continuous enrichment of CTCs even past the occurrence of epithelial-to-mesenchymal transitions. A diagram of the proposed platform is shown in FIG. 1, in which a reservoir of these folate decorated beads would be inserted between two tightly secured <70 μm nylon filters which would allow cells to pass through the reservoir while keeping the beads in place. The proposed method of producing the scaffolds may use commercially available amine decorated silica beads and folic acid conjugated via an amide bond. The proposed synthesis procedure is summarized in FIG. 9. This overall procedure may be performed at a much lower cost than antibody based targeting approaches, and may be in the range of tens of dollars per gram. The total particle size and surface charge will be assessed using a ZetaSizer™. The efficacy of these beads in trapping cells will be assess via flow through experiments with model cell suspensions of established folate receptor overexpressing cell lines such as KB cells and the efficacy of this approach will be compared with already commercially available trapping systems such as Miltenyi MACS™.

Referring to FIG. 9, a scaffold using folate-functionalized amine-containing glass spheres (70 μm) is shown. In one example, amine-functionalized glass spheres (70 μm diameter) were added to a saturated solution of folate in 0.1 M sodium carbonate buffer pH 9 in the presence of a slight excess of the coupling reagent (Hexafluorophosphate Azabenzotriazole Tetramethyl Uronium) HATU. After incubation at 60° C. for 1 hour, spheres were washed 5 times with buffer and deionized (DI) water. Residual water was removed by desiccation.

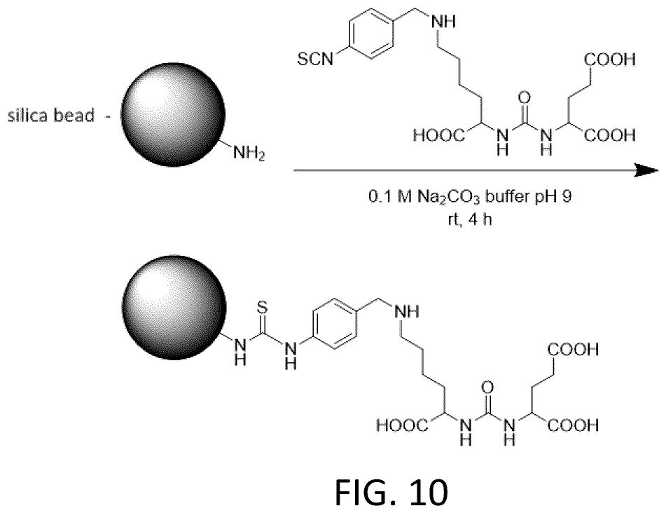

Referring to FIG. 10, in another example, PSMA-functionalized amine-containing glass spheres (70 μm) were designed. Amine-functionalized glass spheres were added to a solution of PSMA-NCS in 0.1 M sodium carbonate buffer pH 9. After incubation at room temperature for 4 hours, spheres were washed 5 times with buffer and DI water. Residual water was removed by desiccation.

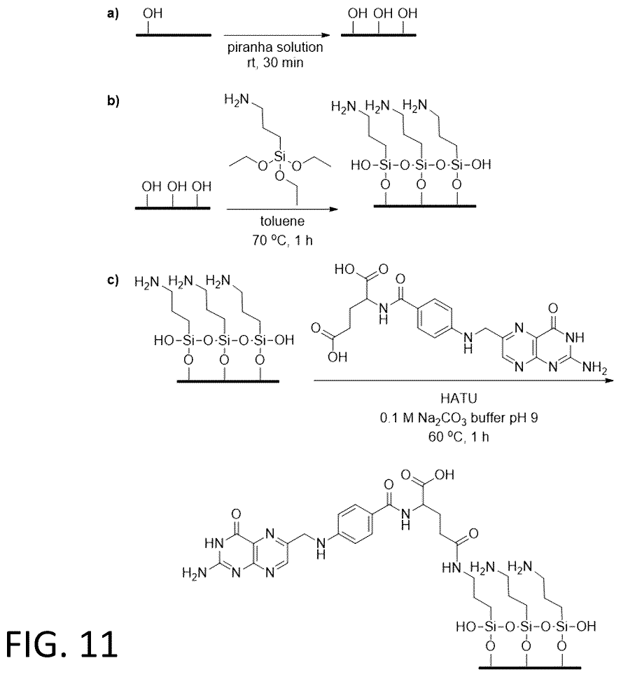

Referring to FIG. 11, a folate-functionalized fiberglass scaffold (9 μm) was also designed. To increase hydroxylation on the surface of the glass fibers, glass fibers 56 (9 μm diameter) were added to piranha solution (3:1 sulfuric acid: hydrogen peroxide). After incubation at room temperature for 30 minutes, fibers were removed from solution and washed with DI water until a near neutral pH was achieved. Residual water was removed with a gentle stream of nitrogen, followed by desiccation, followed by heating to 120° C. for 30 minutes. A 2% (3-aminopropyl)triethoxysilane (APTES) in toluene solution was prepared and heated to 70° C. The treated and dried glass fibers were added to the solution, which was periodically flushed with nitrogen. After incubation at 70° C. for 1 hour, fibers were removed from solution and washed 5 times with toluene. Residual solvent was removed by desiccation. The APTES functionalized fibers were added to a saturated solution of folate in 0.1 M sodium carbonate buffer pH 9 in the presence of a slight excess of the coupling reagent HATU. After incubation at 60° C. for 1 hour, fibers were removed from solution and washed 5 times with buffer and DI water. Residual water was removed by desiccation.

Table 1 below shows the optimization of folate-functionalization reaction conditions consisted of evaluation of different reaction parameters, including piranha acid etch time, APTES concentration, increasing scaffold mass and increasing the number of times the cell suspension is passed through the fibers. Increasing piranha acid etch time did not improve cell trapping and resulted in significant fiber loss, post-etch. Increasing APTES concentration from 2% to 10% did not improve cell trapping. Interestingly, increasing APTES from 2% to 10% and 50% appeared to decrease folate-functionalization, which can be visualized by reduced colour change. Increasing scaffold mass from 25 mg to 100 mg significantly improved cell trapping, with 90% of cells trapped. Doubling the number of times the cell suspension is passed through the fibers also doubled the amount of cells trapped.

TABLE 1

| Experi- | Etch | Post-etch | | Scaffold | Flow | Cell |
|---|---|---|---|---|---|---|
| ment | Time | Recovery | APTES | Mass | Through | Trapping |
| # | (min) | (%) | (%) | (mg) | Repeats | (%) |
| 1 | 30 | 80 | 2 | 33 | X1 | 22 |
| | | | | 25 | X2 | 46 |
| 2 | 30 | 56 | 2 | 25 | X1 | 13 |
| | | | 10 | 25 | X1 | 15 |
| | 90 | 12 | 2 | 25 | X1 | 11 |
| 3 | 30 | 67 | 2 | 100 | X2 | 90 |
| | | | 10 | — | — | — |
| | | | 50 | — | — | — |
| 4 | 15 | 39 | 2 | 100 | X2 | 68 |

Various quantities of folate receptor-expressing KB cells as model CTCs were spiked into 1 mL of bovine white blood cells and passed 2 times through various quantities of the folate-functionalized scaffold, at flow rates up to 850 μL/min. Free CTCs that flowed through the scaffold were collected as a single fraction. Trapped CTCs were liberated from the scaffold by treatment with trypsin for 3 minutes and collected as a single fraction. Flow cytometry was used to quantify cells in each fraction, using an Alexa fluorophore and Hoechst stain to differentiate CTCs from white blood cells.; except for sample 9 (n=3) where 1 single CTC was spiked in and was observed using microscopy. Shown in the table below, results demonstrated that decreasing the CTC quantity to as low as 1 cell still resulted in efficacious CTC trapping.

TABLE 2

| | Pump | Scaffold | | CTC |
|---|---|---|---|---|
| Exper- | Speed | Mass | CTC | Trapping |
| iment # | (μL/min) | (mg) | Quantity | (%) |
| 1 | 660 | 100 | 50 000 | 82 |
| 2 | 850 | 100 | 50 000 | 82 |
| 3 | 330 | 100 | 5 000 | 86 |
| 4 | 660 | 100 | 5 000 | 68 |
| 5 | 850 | 100 | 5 000 | 67 |
| 6 | 850 | 100 | 1000 | 86 |
| 7 | 850 | 200 | 1000 | 89 |
| 8 | 850 | 200 | 10 | 100 |
| 9 | 850 | 200 | 1 | 100 |

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context requires that there be one and only one of the elements.

The scope of the following claims should not be limited by the preferred embodiments set forth in the examples above and in the drawings, but should be given the broadest interpretation consistent with the description as a whole.

What is claimed is:

1. A system for collecting biomarkers from a fluid stream, the system comprising:
a collection vessel having at least one fluid port that is adapted to be in fluid communication with the fluid stream, the collection vessel defining an inner volume;
a 3D scaffold disposed within the inner volume of the collection vessel, the 3D scaffold being chemically functionalized to bind the biomarkers in the fluid stream, wherein the biomarkers are eukaryotic cells of interest, extracellular vesicles associated with the eukaryotic cells of interest, or combinations thereof; and
a fluid driver that is adapted to circulate the fluid stream through the collection vessel via the at least one fluid port such that the fluid stream interacts with the 3D scaffold.

2. The system of claim 1, wherein the 3D scaffold is chemically functionalized to bind uniquely to the biomarkers.

3. The system of claim 1, wherein each of the at least one fluid port is in fluid communication with a bore of a cannula or a lumen of a needle.

4. The system of claim 1, wherein the 3D scaffold comprises beads, fibers, mesoporous structures, or combinations thereof.

5. The system of claim 1, wherein a smallest dimension of the 3D scaffold is larger in size than biological cells in the fluid stream.

6. The system of claim 1, wherein a material of the 3D scaffold comprises silica, glass, quartz, polymer plastics, dielectrics, silicon nitride, gallium nitride, polyethylene glycol, ceramics, or combinations thereof.

7. The system of claim 1, wherein the 3D scaffold has a volume of at least 1 mL.

8. The system of claim 1, wherein the 3D scaffold is functionalized by one or more linker chemistries comprising amine-functionalization, thiol-maleimide, or biotin-streptavidin.

9. The system of claim 1, wherein the 3D scaffold carries targeting compounds that comprise folic acid, RGD peptide, antibodies, peptidomimetics, small molecules, or combinations thereof.

10. The system of claim 1, wherein the 3D scaffold carries targeting compounds that are adapted to bind to EpCAM, EGFR, folate receptors, PSMA, or combinations thereof.

11. The system of claim 1, wherein the fluid driver has a flow rate of at least 1 mL/minute.

12. The system of claim 1, wherein the biomarkers are released from the 3D scaffold using an elution buffer.

13. The system of claim 1, wherein the collection vessel comprises an inlet and an outlet, and wherein the fluid driver draws fluid in via the inlet and exhausts the fluid via the outlet.

14. The system of claim 1, wherein the fluid driver draws fluid in and exhausts fluid via a common fluid port.

15. The system of claim 1, wherein the fluid driver comprises a fluid pump, a reciprocating plunger, or a variable pressure chamber.

16. A method of collecting biomarkers, the method comprising:
connecting at least one fluid port of a collection vessel to a source of fluid, the collection vessel carrying a 3D scaffold within an inner volume defined by the collection vessel, the 3D scaffold being chemically functionalized to bind the biomarkers in a fluid stream, wherein the biomarkers are eukaryotic cells of interest, extracellular vesicles associated with the eukaryotic cells of interest, or combinations thereof;
circulating a fluid stream from the source of fluid through the collection vessel such that the fluid stream interacts with the 3D scaffold and such that the 3D scaffold binds to the biomarkers carried in the fluid stream, wherein at least 10 mL of fluid circulates through the collection vessel;
returning the fluid stream to the source of the fluid; and
releasing the biomarkers from the 3D scaffold into a sample vial.

17. The method of claim 16, wherein connecting the at least one fluid port to a source of fluid comprises using a cannula or a needle.

18. The method of claim 16, wherein at least 100 mL is circulated through the collection vessel.

19. The method of claim 16, wherein the 3D scaffold is functionalized by one or more linker chemistries comprises amine-functionalization, thiol-maleimide, or biotin-streptavidin.

20. The method of claim 16, wherein the 3D scaffold carries targeting compounds that comprise folic acid, RGD peptide, antibodies, peptidomimetics, small molecules, or combinations thereof.

21. The method of claim 16, wherein the 3D scaffold carries targeting compounds that are adapted to bind to EpCAM, EGFR, folate receptors, PSMA, or combinations thereof.

22. The method of claim 16, wherein fluid is circulated through the collection vessel at a rate of at least 1 mL/minute.

23. The method of claim 16, further comprising the step of releasing the cells of interest using an elution buffer.

24. The method of claim 16, wherein the 3D scaffold is chemically functionalized to bind uniquely to the biomarkers such that the sample collected comprises a higher concentration of the biomarkers while maintaining or reducing relative concentrations of background components in the fluid stream.
